(19) United States
(12) Patent Application Publication
(10) Pub. No.: US 2005/0256891 A1
(43) Pub. Date: Nov. 17, 2005

(54) A code or data representation and manipulation system that allows user to view, modify, and manipulate structured entities, such as code or data files, using their tree-like representations.

(75) Inventor: Igor K. Voln, San Ramon, CA (US)

Correspondence Address: IGOR VOLN, 2242 ML KING J. HWY, APT. 1 B, BERKELEY, CA, 94704, US

(73) Assignee: Mr. Igor K. Voln, San Ramon, CA (US)

(21) Appl. No.: 10/709,501

(22) Filed: May 10, 2004

(51) Int. Cl. G06F 17/00

(52) U.S. Cl. 707/101

(57) ABSTRACT

A code or data representation and manipulation system that allows user to view, modify, and manipulate structured entities, such as code or data files, using their tree-like representations

### BACKGROUND OF INVENTION

Structured entity is the content of a file or memory which follows a set of rules, or messages in a protocol. A set of rules define the format of data inside the structured entity. Examples of structured entities are data files, code files, in-memory structures, files that have formats, and different protocols. All such entities, which are governed by a set of rules, have various applications among information technology areas.

Data files are used for storing data and exchanging information between applications. File formats define the structure of data files.

Code files are the files written in different programming or scripting languages. The set of rules, called BNF (Backus-Naur form) or EBNF (Extended BNF) defines the rules for code files. There might be additional rules on top of EBNF as well.

The structured entities consist of pieces that can be logically or semantically grouped using different criteria. Such pieces will be called information pieces hereinafter.

There is no unified way of convenient and comprehensible presentation or manipulation of information pieces inside those structured entities. If you open a large file in a regular plain text or binary editor to view or modify the content of the file, it is relatively difficult to navigate to where a specific part of information is stored. The content often contains multiple formatting characters that make the navigation process even harder.

When the content of a file is modified, there exists the probability of making a mistake or introducing to the file content that does not meet the original structure rules or breaks the file format. Although the changes might look correct, the file becomes “broken”, its structure does not follow the rules anymore. A file where the format or rules are broken could easily become inconsistent or not acceptable by applications that use it. The user may not discover the inconsistencies until the file is submitted to a system that requires a file in a specific format. The system will have to process all the previous records and even perform many other operations before it discovers the error. Such an action could potentially take a significant amount of time depending on input size, system complexity, hardware performance, and other factors.

Similar problems exist for files with code written using a programming or scripting language. Such files are usually edited within a special environment that gives user some advantages over regular plain text editor such as, for example, syntax coloring and highlighting. However, these environments still do not preserve users from making mistakes. The errors in files written in programming languages will show up only after the compilation or building process, which could take hours, or even days, depending on the size of the project. Another lengthy compilation or building process may be required after the error is discovered and corrected.

An additional drawback of currently used environments is that usually the user does not have the ability to work on the content of the file in small parts. Modifying a small part is easier and less error-prone. If users had the ability to modify small parts of the same file separately, more then one user could work on the same file at the same time, which would increase productivity and lead to a finer level of source control.

U.S. Pat. No. 6,466,240 considers the problems mentioned above and suggests using a data processing system for interactively building a computer program that transforms a tree that represents structured text. However, the patent mentioned above does not provide a complete way of resolving the technical problems. First of all, no method of building such trees is mentioned. The patent describes the manipulations using the tree given that the tree is already built. Meanwhile, building a tree given a structured entity actually plays a key role in the whole method of developing programs in this way. Some of the drawings included in the patent show that nodes of the tree are logically related to a piece of text in the structured text. Nothing is said about the ways of preparing such logical grouping for each program. Secondly, the scope of the claims is restricted to only a few particular types of structured entity and does not handle all types. Thirdly, the system requires the presence of at least two graphical user interface elements, one of which is the tree and another one is the window that shows the changes in the content according to the changes to the tree.

### SUMMARY OF INVENTION

The present invention aims to provide a way to resolve the problems described above by using specially built tree-like representations. It is suggested that instead of or in addition to regular presentation, every structured entity could be presented as a tree-like view based on the content itself and some additional rules. Tree-like means indentation and the ability to hide subsections of content.

As opposed to U.S. Pat. No. 6,466,240, the present invention suggests a revolutionary completely new universal way of building trees for any kind of structured entities, where the the nodes of the tree could be a piece of text in structured text, no other logical grouping is required, and any kind of structured entity can be handled by a system using described method. These trees are not any kind of underlying trees mentioned in the patent described above. They are built based on a unique and completely new algorithm, could be dynamic, and could depend on user preferences or the data inside the structured entity itself.

Each structured entity type can be described with a set of rules. For example, BNF/EBNF, which is widely used to define grammars for programming languages, provides a set of such rules. This set of rules can be extended by additional rules, for example, for verification or validation purposes.

According to the present invention, each rule is coupled with its tree like representation. The tree-like representation for each rule is based on the desired representation pattern for this rule in the main tree-like document that represents an instance of a structured entity and will be constructed later. This coupling can be static (hard-coded) or dynamic (built at run time based on the content of a structured entity or other factors).

Then when there is a need to build a tree-like representation for an instance of a structured entity (file), those rules are used to map the file content onto those individual trees for each rule and the resulting main tree is built.

As a result of present invention, structured entities are presented as at least one tree-like structure.

The tree-like form is easier for reading, editing, and manipulation, all unessential items in the output can be removed or “grayed” and the main aspects can be highlighted and underlined without actual modification of the original content.

The result of such representation gives a number of advantages:

1. Easier comprehension. More important nodes can be placed at the higher level in the tree or highlighted in another way, and less important nodes can be placed at the lower levels or even hidden. Less important nodes can be shown by drilling down (expanding parent nodes) or by other kinds of additional requests from the user. Thus, a quick look would be enough to find the right information piece inside the structured entity.

2. During modification, the structured entity rules can be enforced before the actual modification occurs. The results of node creating, editing, or deleting can be easily verified by the same set of rules and presented as tree-like structures as well. If changes to one or more of the nodes are not correct, the tree-like structure based on the structured entity rules cannot be created, and the modifications won't be accepted. This reduces the number of editing errors to minimum. Many kinds of errors simply cannot be made, as the system won't accept them.

3. The trees built in this way can be edited or viewed on the node-by-node basis. Each node or set of nodes can be presented to the user and processed separately from the main tree-like structure. At the same time it could still act as a part of the main tree-like view or be merged back later. This removes unrelated parts of the structured entity from the user's view and lets the user focus only on the structured entity parts related to the required manipulations. It simplifies working with structured entities, especially with large ones.

4. The input verification can become much quicker. There is no need to analyze and process the whole file as it is done in case of compilation and building of code written in a programming language, for example. This process often takes a lot of time, CPU cycles, and other resources. Instead, each node (or a set of nodes) can be considered as a standalone structured entity that must follow a subset or rules, defined for this node/nodes. Each record can be edited in place or using a separate instance of application to isolate it from other records and make sure they are not affected or changed unintentionally. While the record is being changed, changes that do not meet the grammar rule simply cannot be entered, which dramatically reduces the probabilities of any errors. So, only this small piece of input is modified and verified. However, the quality of verification is still the same. The method utilized by this invention saves time and other resources.

5. Tree-like representation makes the process of adding, removing, or editing records much easier. For example, there is no need to scroll through the file to find the right place and copy it, then, find another place, and paste it there. All it takes is selecting a set of nodes in one tree and dragging and dropping it on another or the same tree. The source tree already verified the information pieces that are being transferred. The target tree verifies that the information pieces can be inserted at this location and whether this insertion does not break the rules. The process described is much more advantageous in comparison with simple editing, adding, or deleting pieces of input using regular environments.

6. As the representation type can be selected based on preferred criteria, searching becomes much easier as all the unnecessary elements can be either hidden or leveled so that the values by which the search is performed are emphasized.

7. Code or data indentation within files is automatically presented by the tree-like structures. The representation can format any structured entity in any usable way according to the preferences of the viewer.

### BRIEF DESCRIPTION OF DRAWINGS

FIG. 1 shows an example of original representation of a data file in CSV (comma separated values).

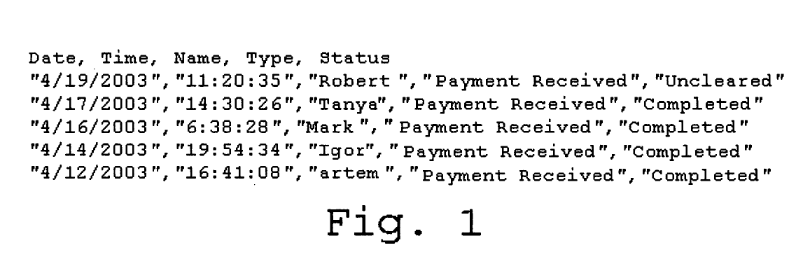

FIG. 2 shows an example of a tree-like representation of a file in CSV shown on FIG. 1.

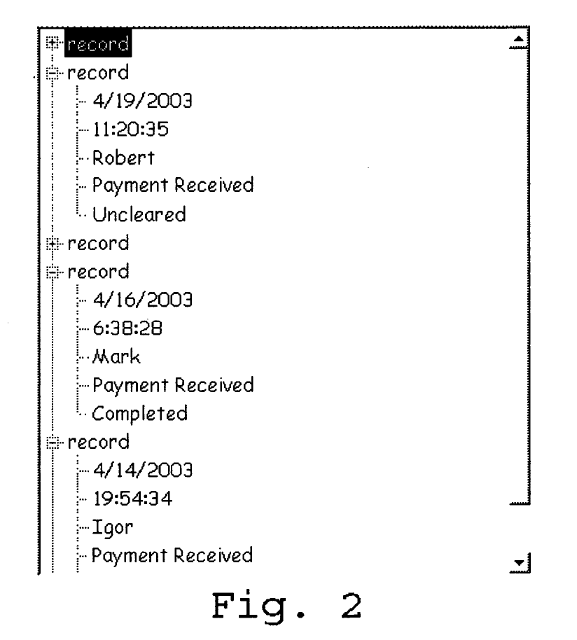

FIG. 3 shows an example of another tree-like representation of a file in CSV shown on FIG. 1 where the name is emphasized.

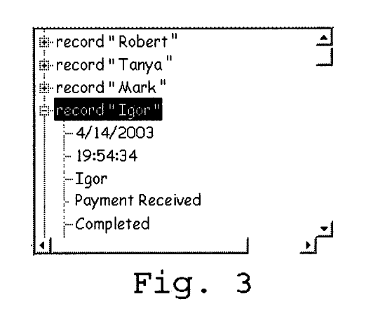

FIG. 4 shows an example of original representation of a code file in C Sharp

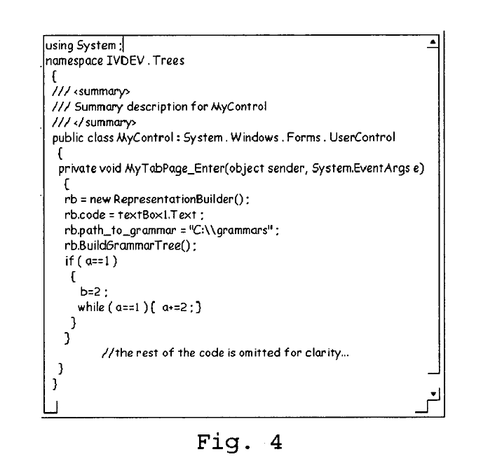

FIG. 5 shows an example of a tree-like representation of a file in C sharp shown on FIG. 4.

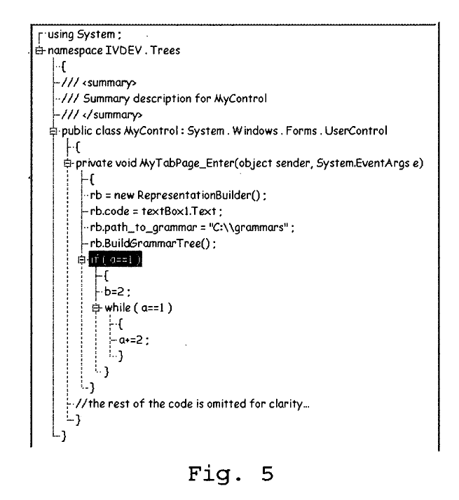

FIG. 6 shows an example of original representation of a code file in PHP.

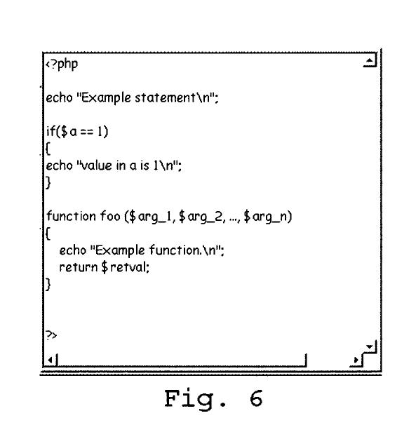

FIG. 7 shows an example of a tree-like representation of a file in PHP shown on FIG. 6.

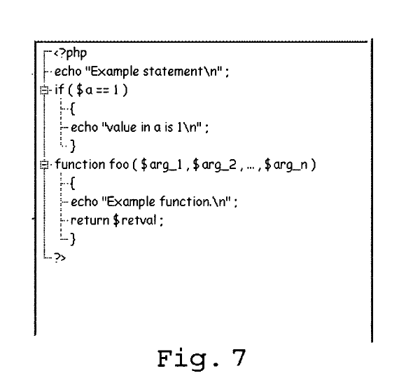

FIG. 8 shows a mapping of one rule for the if statement to a tree like structure

FIG. 9 shows the example of an if statement representation, resulting from the mapping described on FIG. 8.

FIG. 10 shows another mapping of the same rule for the if statement to a tree like structure.

FIG. 11 shows the example of an if statement representation, resulting from the mapping described on FIG. 10.

FIG. 12 shows an example of editing an if statement separately from the rest of the program.

FIG. 13 shows an example of the original grammar tree for a CSV grammar.

FIG. 14 shows a combined for convenience purposes table illustrating two particular cases of mapping for an if statement in a C++or C sharp-like programming language.

### DETAILED DESCRIPTION

1. Structured Entities as Grammars.

Structured entities are widely used in information technology areas for different purposes. Structured entities have different formats and follow different rules. Those formats and rules can be potentially described as at least one set of rules in BNF/EBNF format (or similar). A set of such rules is called a grammar. For example, code file formats in programming languages are based on BNF/EBNF grammars.

2. Rules in Grammars.

Such grammars consist of rules. Each rule corresponds to a structure that could be encountered inside the structured file. A couple of examples of rules like that is shown below:
while_statement::=“while” “(“boolean_expression”)” embedded_statement;
line ::=value “,” line | value “,” | value;

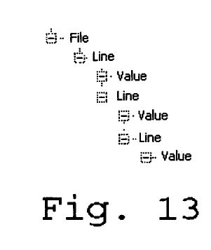

If we take an instance of a structured entity and a related grammar we can construct the grammar tree for this instance. If the structured entity meets all the rules of the grammar, the tree will be complete or otherwise be partial. An example of such grammar tree for an instance of a CSV file and a particular grammar is shown on the FIG. 13.

For more information about grammar trees and how they are constructed please see publicly available books about compilers, shift-reduce parsers, and BNF/EBNF.

3. Mapping Rules—Representations.

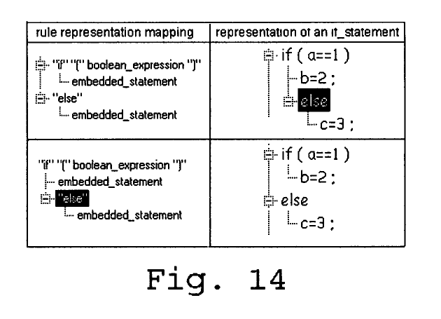

The invention suggests that each rule in the grammar can be mapped to a tree-like representation of the rule elements. The example of such mapping for an IF statement is shown on the FIG. 14.

In the left column of the table you can see two different ways to map the rule to a tree-like structure for the following rule:
If_statement ::=“if” “(“boolean_expression”)” embedded_statement “else” embedded_statement

Please refer to BNF/EBNF manuals for more information about BNF/EBNF rules themselves.

According to the invention, such mappings can be used to build the tree-like representations for each instance of a structured entity.

4. An Example of a Representation Building Process.

Based on the original structured entity content or its part a BNF/EBNF tree is built first. Then it is converted to the representation tree using the mappings. An example of this process for a file in C++ or C sharp is shown on the FIG. 14. In this example, a code file is considered as a structured entity, and the line
if (a==1) b=2; else c=3; (1)
is considered as an information piece. An example of a related rule from the grammar for the files of this type is shown below:
If_statement ::=“if” “(“boolean_expression”)” embedded_{—}statement “else” embedded_statement
Note: The rules for Boolean_expression and embedded_statement in the expression above are omitted for clarity

It can be read as: an if_statement structure should start with an “if”, followed by a “(”, then a boolean_expression type of structure, then “)”, then an embedded_statement type of structure, then “else”, then an embedded_statement type of structure.

The next step is to assign a tree-like representation to rules. Tree like representation is selected based on user needs or other factors, which include but are not restricted to easy and logical presentation and manipulation. The representations could also ba dynamically constructed or depend on the content of the structural entity.

Two possible representations for the if_statement rule described above are shown on FIG. 14 in the left column.

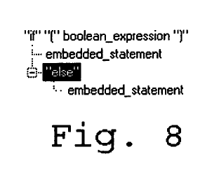

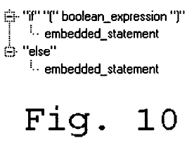

They are also shown on FIG. 8 and FIG. 10. Both add the inner content of the if_statement type of structure as a group of parent-child relationships, so that they can be originally hidden and expanded by a user only if the user is interested to look at them.

When the original line of code (1) is parsed, the representation is used to convert this text to a tree-like structure based on the rule representations described above. The examples of final results are shown on FIG. 14 in the right column. Note, to construct the tree parts in the right columns the rule for “embedded statement” has been processed in the same way and this process is not described here only for simplicity reasons. The user can now collapse the content of the if-node, which greatly simplifies the comprehension of the code at a higher level. The manipulations are made easier as well because the node can be edited, copied, removed or manipulated in any other way as a whole, with all of its content. If the node is being copied to another tree, for example, the user could be presented with a dialog to edit the content of the node in a tree like or just textual form before pasting the node into the target tree.

It is to be understood that the if_statement is just an example and the same technology can be applied to any kind of structured entity that can be put in rules.

5. Representation Types (Different Mapping of the same In-puts).

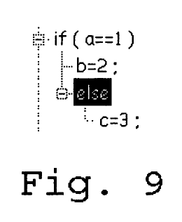

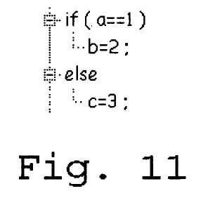

Different mappings will result in different tree structures. See the example of two representations of an if_statement on FIGS. 8 and 10. The resulting tree structures shown on FIGS. 9 and 11 are different. One representations shows the “else” part on the same level as the “if” part and another one shows the “else” part as a child of the “if” part which can be more logical in some situations. FIG. 14 shows two mentioned above representations and resulting tree-like structures as a table.

6. Additional Drill Down, Sub-Representations for Node of Each Type.

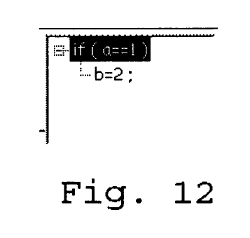

It is possible to edit each node of a representation tree by opening it as a separate tree and focusing only on it. Example is shown on FIG. 12 where an if statement type is presented as a separate tree. Now it can be modified separately from the main tree and merged with it later. Also additional drilling down is possible for each node based on its meaning and content. If a tree node has it own inner content and grammar, opening it as a separate tree could completely or partially reveal that content in an easy way. It could be shown as a tree-like structure based on its own grammar and rules. For example, it is possible to show machine code or execution time and statistics for each tree node for the case of a programming language based tree.

6. Enforcing the Rules while Changing the Content. Comparative Analysis of Regular Compilation vs. Suggested Tree Building.

Any changes can be parsed back to the tree using the same rules. It means that changes that do not meet the rules will not be possible. For example, if we edit the if_statement separately, as described in 6, and the resulting changes do not meet the rules, it can be determined and reported before the code is merged back to the main tree. Only the trees that meet the rules can be merged with the main tree, and only the changes that meet the rules can be made, which greatly reduces the number of errors and time, spent by compiler at build/compilation time to check that the code follows the rules.

7. Building a Representation for a Binary File.

Binary files can also be presented as a tree like representation. For example, a picture in BMP format can be presented as a tree, where nodes are image sizes, creator, dates, format identifiers, and a set of lines of the image. In that way binary resources can be easily manipulated on the low level and are just a particular case of a structured entity, which means that all that is described in this invention is equally applicable to them too.

8. Code Copying Examples.

The code or data presented in this tree-like way can be easily copied/replicated/manipulated in logically grouped pieces. For example, you could copy the entire content of an if_statement, just as you copy a folder in windows explorer. Multiple tree nodes can also be involved in the operation at the same time. This simplifies the code management and makes code composition easier. It is also profitable to implement source control based on such nodes and not on the whole file. In this way, multiple people could lock and manipulate different nodes in the same file at the same time.

The invention being thus described, it will be evident that the same may be varied in many ways. Such variations are not to be regarded as a departure from the spirit and scope of the invention and all such modifications are intended to be included within the scope of the claims.

1. A method of representation and manipulation of a structured entity that presents data in a tree-like form based on mapping of every rule from the set of structure defining rules to dynamically or statically created tree-like representation. This mapping is then used for building and manipulating tree-like representation of instances of a structured entity.

2. A method according to claim 1 wherein the rules are a BNF/EBNF grammar.

3. A method according to claim 2 wherein the input (instance of a structured entity) is a piece of code in a programming language, or data, or binary file, or a communication protocol message(s).

4. A method according to claim 1 further comprising the steps of: providing a plurality of trees wherein each tree is coupled to its own programmable representation which is based on the structured entity type or content, and changing the representation of structured entities from a conventional state (text) to a related representation state.

5. A method according to claim 1 further comprising the steps of creating, modifying, manipulating, and deleting representations. The representations could also be static (Oust based on the rules) or dynamic (build dynamically based on the rules and/or other factors, such as structured entity content). If a rule representation changes, the structured entity representation can be dynamically rebuilt according to the appropriate version of the rule representation.

6. A method according to claim 3 further comprising the steps of writing programs or modifying data by creating, modifying, copying, moving, and deleting of single nodes and sets of nodes in such specifically built tree-like representation of the structured entity.

7. A method according to claim 1 further comprising of creating a set of tree-like structures and a way to move pieces of structured entity based on representation to another or the same structured entity to modify it via its tree-like representation.

8. A method according to claim 1 further comprising the opportunity to drill-down the nodes of the tree-like representation to create another instance of representation of structured entity that includes only a subset of the nodes of the original structured entity. This new instance can be edited separately and dynamically represent the original subset of nodes in the original structured entity or becomes a standalone instance of structured entity, that could be merged back to the original tree later.

9. A method according to claim 1 further comprising the opportunity to drill-down the nodes of the tree-like representation to expand the underlying properties of the structured entity or expose the related content, which could also be represented according to the claim 1.

10. A method of editing content using tree-like representation according to claim 1 that does not let the user enter the content that does not conform to the related grammar or verifies the changes at the time of the merge to determine which ones can and which ones can't be applied, and notifies the user.

11. A method according to claim 1 when the user is not a person, but a program.

12. A method according to claim 1 where instances of a structured entity are modified using both its regular representation and the tree like representation described in the present invention.

13. A method of source control based on the tree-like representation according to the claim 3, when the content is locked for manipulations at the level of nodes or sets of nodes of the tree, so that multiple users can work on different parts of the content of the same structured entity (file) simultaneously.

14. A method according to claim 1 where the representations are built by the user according to the user's needs or preferences.

15. A method according to claim 3 where the tree-like representation for code files is built according to the commonly accepted code indentation rules.

16. A method according to claim 1 where a prerecorded sequence of actions can be applied to a set of nodes of tree-like representation based on the factors common for the set of nodes or their content.
